(19) United States
(12) Patent Application Publication
(10) Pub. No.: US 2014/0123511 A1
(43) Pub. Date: May 8, 2014

(54) HEIGHT MEASURING DEVICE FOR CAVITY

(71) Applicants: HON HAI PRECISION INDUSTRY CO., LTD., New Taipei (TW); HONG FU JIN PRECISION INDUSTRY (SHENZHEN) CO., LTD., Shenzhen (CN)

(72) Inventor: BING-JUN ZHANG, Shenzhen (CN)

(73) Assignees: HON HAI PRECISION INDUSTRY CO., LTD., New Taipei (TW); HONG FU JIN PRECISION INDUSTRY (SHENZHEN) CO., LTD., Shenzhen (CN)

(21) Appl. No.: 13/901,582

(22) Filed: May 24, 2013

(30) Foreign Application Priority Data
Nov. 6, 2012 (CN) 2012104377421

(51) Int. Cl. G01B 5/02

(52) U.S. Cl. CPC G01B 5/02
USPC 33/542.1

(57) ABSTRACT

A height measuring device for a cavity includes a main body, a fastening member fastened to the main body, a scale, a measuring pole, a motion pole, and a transition member. The scale is fastened to an end of the main body, and includes a stretchable measuring head. The measuring pole is slidably mounted to the main body up and down. The motion pole is horizontally and slidably mounted to the fastening member. The transition member includes a pivoting portion and two perpendicular transition poles. The pivoting portion is rotatably connected to the fastening member. One of the transition poles abuts against a first end of the motion pole. The other transition pole abuts against a bottom end of the measuring pole.

### BACKGROUND

1. Technical Field

The present disclosure relates to a device for measuring height of a cavity.

2. Description of Related Art

A chassis of a blade server generally defines a plurality of cavities, to receive a plurality of server units. A height of each cavity is needed to be measured, to know if the corresponding server unit can be mounted in the cavity. The height of the cavity is generally measured by a caliper. However, the caliper can only measure the height of an inlet of the cavity; the height of the deep position of the cavity cannot be measured.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a height measuring device.

FIG. 2 is an assembled, isometric view of FIG. 1.

FIG. 3 is an isometric view of the height measuring device of FIG. 2, together with a cushion block and a proofreading member.

FIG. 4 is an isometric view of a chassis to be measured by the height measuring device of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

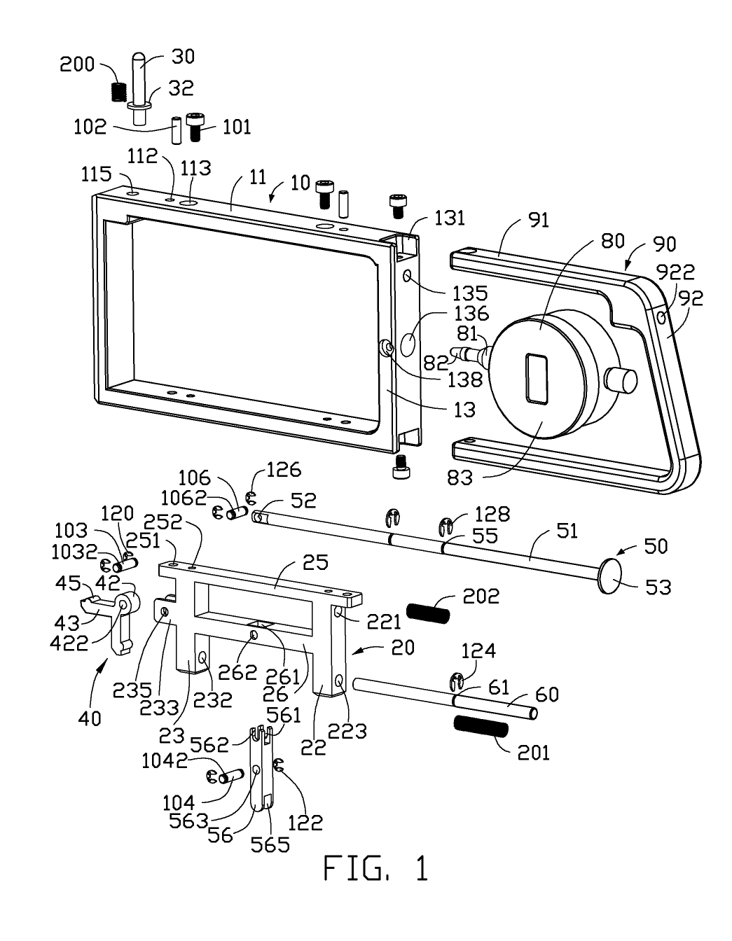

FIG. 1 shows an exemplary embodiment of a height measuring device. The height measuring device includes a main body 10, a fastening member 20, a measuring pole 30 with a stop tab 32 extending from a circumference of the measuring pole 30, a transition member 40, a transmission member 50 including a transmission pole 51 and a linkage pole 56, a motion pole 60 defining an annular hooking slot 61 in a middle of a circumference of the motion pole 60, a scale 80, and a handle 90.

The main body 10 is a rectangular and hollow frame, including a top plate 11 and a side plate 13 extending down from an end of the top plate 11. Two through holes 112 are defined in the top plate 11. Two locking holes 113 are defined in the top plate 11, located between the through holes 112. A through hole 115 is defined in the top plate 11, located at an end of the top plate 11 away from the side plate 13. Two recesses 131 are defined in top and bottom ends of the side plate 13. A through hole 135 is defined in the side plate 13, near and parallel to the top plate 11. A middle of the side plate 13 defines a through hole 136 parallel to the top plate 11, and a through hole 138 perpendicular to the communicating with the through hole 136.

The fastening member 20 includes a first pole 22, a second pole 23 parallel to the first pole 22, a top pole 25 perpendicularly connected between top ends of the first pole 22 and the second pole 23, and a middle pole 26 perpendicularly connected between the middles of the first pole 22 and the second pole 23. Two engaging holes 251 are defined in a top surface of the top pole 25. Two screw holes 252 are defined in the top surface of the top pole 25, located between the engaging holes 251. A through slot 261 is defined in a middle of the middle pole 26. A through hole 262 is defined in the middle pole 26, extending through opposite sides of the middle pole 26, and perpendicular to and communicating with the through slot 261. A through hole 221 is defined in the first pole 22, above the middle pole 26 and parallel to the top pole 25. A through hole 223 is defined in the first pole 22, below the middle pole 26 and parallel to the top pole 25. A through hole 232 is define in the second pole 23, aligning with the through hole 223. Two pivoting tabs 233 extend from the second pole 23 away from the first pole 22. A pivot hole 235 is defined in each pivoting tab 233.

The transition member 40 includes a pivoting portion 42, and two transition poles 43 extending from the pivoting portion 42. The transition poles 43 are the same in length and perpendicular to each other. A pivot hole 422 is defined in the pivoting portion 42. A protrusion 45 protrudes from a distal end of an outer side of each transition pole 43 opposite to the other transition pole 43. Distances from the protrusions 45 to the pivot hole 422 are equal.

A through hole 52 is defined in a first end of the transmission pole 51. A button 53 is formed on a second end of the transmission pole 51. Two annular hooking slots 55 are defined in a middle of a circumference of the transmission pole 51.

A receiving slot 561 is defined in a top end of the linkage pole 56, extending through opposite sides of the linkage pole 56, an opening 562 is defined in the top end of the linkage pole 56, extending through the other two opposite sides of the linkage pole 56 and communicating with the receiving slot 561. A through hole 563 is defined in a middle of the linkage pole 56, extending through the other two opposite sides of the linkage pole 56. A through slot 565 is defined in a bottom end of the linkage pole 56, extending through opposite sides of the linkage pole 56.

The scale 80 includes a display portion 83 for displaying the reading of the scale 80, a mounting portion 81 extending from the display portion 83, and a measuring head 82 extending from the mounting portion 81 and opposite to the display portion 83. The measuring head 82 is stretchable.

The handle 90 is substantially U-shaped, and includes two parallel mounting poles 91 and an operation pole 92 connected between ends of the mounting poles 91. A through hole 922 is defined in the operation pole 92, parallel to the mounting poles 91 and near a top end of the operation pole 92.

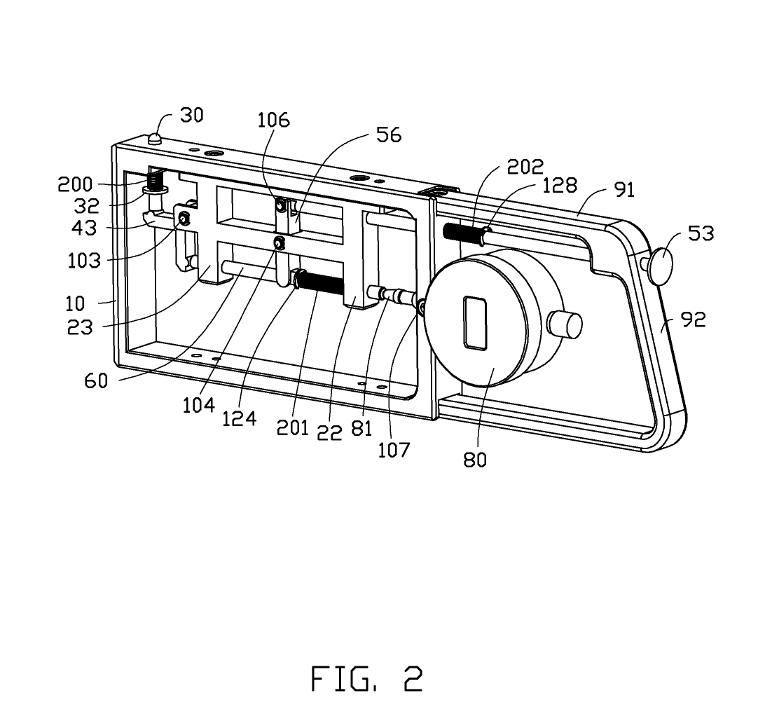

FIG. 2 shows in assembly. The fastening member 20 is placed in the main body 10. Two screws 101 extend through the locking holes 113 and engage in the screw holes 252. Two pins 102 extend through the through holes 112 and engage in the engaging holes 251. Therefore, the top pole 25 is fastened to a bottom surface of the top plate 11. The first pole 22 is near the side plate 13.

A resilient member 200 is placed around the measuring pole 30 and supported on the stop tab 32. The measuring pole 30 is placed under the top plate 11, and slidably extends through the through hole 115. The pivoting portion 42 is sandwiched between the pivoting tabs 233. A pin 103 extends through the pivot holes 235 and 422, to rotatably connect the transition member 40 to the fastening member 20. Two clips 120 engage in two hooking slots 1032 defined in opposite ends of the pin 103, and abut against outer sides of the pivoting tabs 233. One of the protrusions 45 abuts against a bottom end of the measuring pole 30.

The top end of the linkage pole 56 extends through the through slot 261 from a bottom of the fastening member 20. A pin 104 extends through the through holes 262 and 563, to rotatably connect the linkage pole 56 to the fastening member 20. Two clips 122 engage in two hooking slots 1042 defined in opposite ends of the pin 104, and abut against the opposite sides of the middle pole 26.

A first end of the motion pole 60 slidably extends through the through holes 136 and 223, a resilient member 201, the through slot 565, and the through hole 232. The resilient member 201 is compressed to expose the hooking slot 61. A clip 124 engages in the hooking slot 61. The resilient member 201 is released. Opposite ends of the resilient member 201 abut against the clip 124 and the first pole 22. The resilient member 201 resists the clip 124 and the motion pole 60 to move toward the transition member 40. The first end of the motion pole 60 abuts against the other protrusion 45, to resist the transition member 40 to rotate clockwise. The upper protrusion 45 pushes the measuring pole 30 to move up and compress the resilient member 200. Ends of the mounting poles 91 away from the operation pole 92 are fastened to the recesses 131. The first end of the transmission pole 51 extends through the through hole 922, a resilient member 202, the through holes 135 and 221, and engages in the receiving slot 561. The hooking slots 55 are located at opposite sides of the side plate 13.

A pin 106 extends through the opening 562 and the through hole 52. Two clips 126 engage in two hooking slots 1062 defined in opposite ends of the pin 106, and abut against the corresponding sides of the linkage pole 56. The resilient member 202 is compressed to expose the hooking slots 55. Two clips 128 engage in the hooking slots 55.

The measuring head 82 extends through the through hole 136 and abuts against a second end of the motion pole 60. A screw 107 extends through the through hole 138 and abuts against the mounting portion 81, to fasten the scale 80 to the main body 10.

The button 53 is pressed toward the main body 10. The resilient member 202 is compressed by the clip 128. The transmission pole 51 pushes the pin 106, to push an upper portion of the linkage pole 56 to rotate away from the handle 90 about the pin 104, thus a lower portion of the linkage pole 56 rotates toward the handle 90. The lower portion of the linkage pole 56 pushes the clip 124. The resilient member 201 is compressed. The motion pole 60 moves toward the scale 80. The measuring head 82 is contracted. The resilient member 200 is restored, to push down the stop tab 32. The measuring pole 30 moves down. The measuring pole 30 pushes the upper protrusion 45, to make the transition member 40 rotate counterclockwise. Thereby, the lower protrusion 45 still abuts against the first end of the motion pole 60.

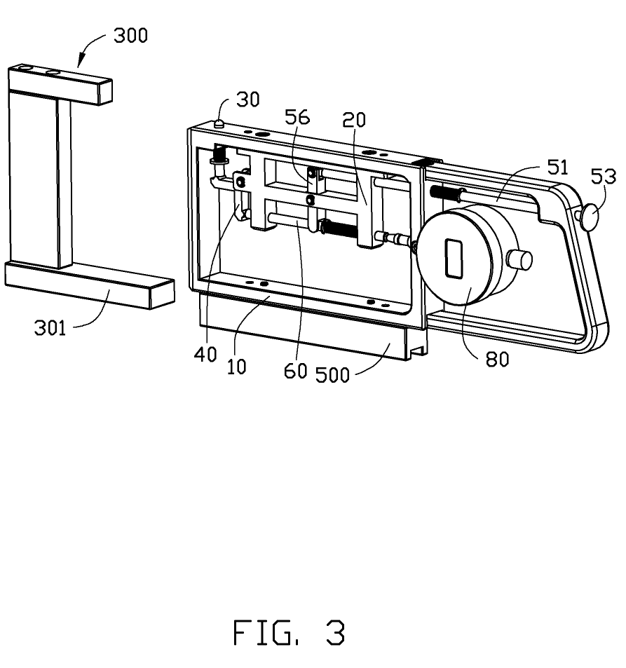

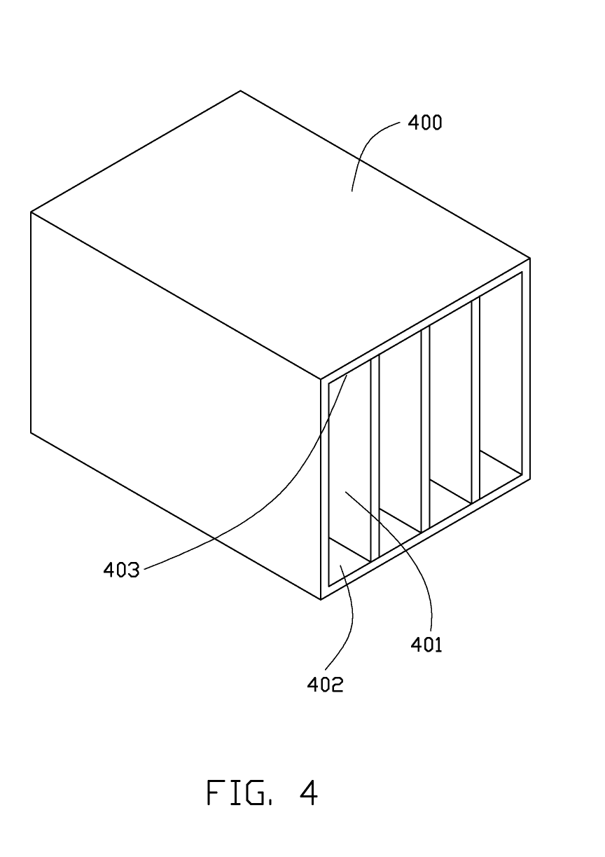

FIGS. 3 and 4 show that in use, the reference reading of the scale 80 can be determined by a proofreading member 300. The proofreading member 300 includes two parallel blocks 301. A distance between inner surfaces of the blocks 301 is m. The main body 10 is placed on the inner surface of the lower block 301. The measuring pole 30 is located below the upper block 301. The button 53 is released. The resilient member 202 is restored, to bias the transmission pole 51 to move away from the main body 10. The upper portion of the linkage pole 56 rotates toward the handle 90, and the lower portion of the linkage pole 56 rotates away from the handle 90. The resilient member 201 is restored, and pushes the clip 124. The motion pole 60 moves toward the transition member 40 and pushes the lower protrusion 45. The measuring head 82 stretches, keeping abutting against the second end of the motion pole 60. The transition member 40 rotates clockwise, to bias the measuring pole 30 to move up. The measuring pole 30 abuts against the inner surface of the upper block 301. Define the distance from a top dot of the measuring pole 30 to a bottom surface of the main body 10 as L. Now, L=m, the reading n1 of the scale 80 is the reference reading of the scale 80. Because of the transition poles 43, the distance of the measuring pole 30 moving up and down is the same as the distance of the motion pole 60 moving horizontally.

To measure a height of a cavity 401 of a chassis 400. The button 53 is pressed toward the main body 10, to move the measuring pole 30 down. The main body 10 is placed deeply in the cavity 401 and supported on a bottom wall 402 of the cavity 401. The button 53 is released. The measuring pole 30 moves up and abuts against a top wall 403 of the cavity 401. Now, the reading of the scale 80 is n2. The height of the cavity 401 is d, wherein d=m+(n2−n1).

In the embodiment, the resilient members 200, 201, and 202 are all springs.

If the height of the main body 10 is greatly less than the height of the cavity 401. A cushion block 500 having a height z can be attached to the bottom surface of the main body 10 and supported on the bottom wall 402. As a result, d=m+z+(n2−n1).

In a second embodiment, the proofreading member 300 is replaced by a caliper. The caliper is used to measure the distance L from the top dot of the measuring pole 30 to the bottom surface of the main body 10. Obtain the reading n1 of the scale 80. The main body 10 is placed on the bottom wall 402. The measuring pole 30 abuts against the top wall 403. The reading of the scale 80 is changed to n2. The height of the cavity 401 is d, wherein d=L+(n2−n1).

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A height measuring device for a cavity, comprising:
a main body;
a fastening member fastened to the main body;
a scale fastened to an end of the main body and comprising a stretchable measuring head;
a measuring pole slidably mounted to the main body, operable to move up and down, and extending beyond a top surface of the main body;
a motion pole horizontally and slidably mounted to the fastening member; and
a transition member comprising a pivoting portion and two perpendicular transition poles extending from the pivoting portion, the pivoting portion rotatably connected to the fastening member, one of the transition poles abutting against a first end of the motion pole, the other transition pole abutting against a bottom end of the measuring pole, the transition poles being the same in length;
wherein when the measuring head abuts against a second end of the motion pole, a distance from a top dot of the measuring pole to a bottom surface of the main body is L, the reading of the scale is n1, the main body is placed on a bottom wall of the cavity, the motion pole moves toward the transition member, the transition member rotates to push the measuring pole to move up, the measuring pole abuts against a top wall of the cavity, the reading of the scale is changed to n2, thus the height of the cavity is d=L+(n2−n1).

2. The height measuring device of claim 1, wherein the main body comprises a top plate and a side plate extending down from an end of the top plate, the fastening member comprises a first pole and a second pole both perpendicular to the top plate, the motion pole is parallel to the top plate and slidably extended through the first pole and second pole, the measuring pole is parallel to the side plate and slidably extended through the top plate.

3. The height measuring device of claim 2, further comprising a linkage pole and a transmission pole parallel to the top plate, wherein the fastening member further comprises a middle pole connected between the first pole and the second pole, the linkage pole is rotatably connected to the middle pole, and the transmission pole is slidably extended through the side plate and the first pole, to be connected to a top end of the linkage pole, the transmission pole is operable to be moved to rotate the linkage pole, the linkage pole pushes the motion pole to move toward the measuring head.

4. The height measuring device of claim 3, wherein a clip is mounted to the motion pole, located between the linkage pole and the first pole, a resilient member is placed around the motion pole and sandwiched between the clip and the first pole, the linkage pole rotates to push the clip, to make the motion pole move toward the measuring head and make the resilient member be deformed.

5. The height measuring device of claim 3, wherein a handle is fastened to opposite ends of the side plate, the transmission pole slidably extends through the handle, a button is formed on the transmission pole and is located out of the handle.

6. The height measuring device of claim 3, wherein a clip is mounted to the transmission pole and located out of the main body, a resilient member is placed around the transmission pole and sandwiched between the side plate and the clip.

7. The height measuring device of claim 2, wherein the pivoting portion is rotatably connected to the second pole.

8. The height measuring device of claim 7, wherein two pivoting tabs extend from the second pole away from the first pole, the pivoting portion is rotatably connected between the pivoting tabs.

9. The height measuring device of claim 7, wherein a protrusion protrudes from each transition pole, distances from the protrusions to the pivoting portion are equal, the protrusions respectively abut against the measuring pole and the motion pole.

10. The height measuring device of claim 2, wherein the fastening member further comprises a top pole connected between top ends of the first pole and second pole, two screws extend through the top plate and engage in the top pole, two pins extend through the top plate and engage in the top pole.

11. The height measuring device of claim 2, wherein a stop tab is formed on the measuring pole and located below the top plate, a resilient member is placed around the measuring pole and sandwiched between the stop tab and the top plate.
